(19) United States
(12) Patent Application Publication
(10) Pub. No.: US 2003/0020553 A1
(43) Pub. Date: Jan. 30, 2003

(54) Tunable superconductor resonator or filter

(75) Inventors: Erzhen Gao, Milburn, NJ (US); Qiyuan Ma, Milburn, NJ (US)

Correspondence Address: Daniel H. Golub, Morgan, Lewis & Bockius LLP, 1701 Market Street, Philadelphia, PA, 19103-2921, US

(73) Assignee: Supertron Technologies, Inc.

(21) Appl. No.: 09/956,670

(22) Filed: Sep. 20, 2001

Related U.S. Application Data
(60) Provisional application No. 60/308,394, filed on Jul. 26, 2001.

(51) Int. Cl. G01J 5/00

(52) U.S. Cl. 331/66

(57) ABSTRACT

A tunable superconductor apparatus or associated method. The apparatus comprises a coil, a first superconductor film portion, a second superconductor film portion, and an actuator. The first superconductor film portion is electrically coupled to the coil. The second superconductor film portion is inductively coupled to the first superconductor film portion. Displacement of the second superconductor film portion relative to the first superconductor film portion changes the capacitance between the second superconductor film portion and the first superconductor film portion. The actuator is capable of relatively displacing the second superconductor film portion and the first superconductor film portion to change a resonant frequency of the tunable superconductor apparatus. In one aspect, the actuator includes a Micro-Electromechanical (MEM) component or a mini electric-motor component that have the capability of relatively displacing the second superconductor film portion and the first superconductor film portion. The superconductor apparatus is configured, for example, as a resonator or as a filter in the frequency range of 1 MHz to 10 GHz.

CROSS-REFERENCE TO RELATED APPLICATIONS

This application claims priority to U.S. Provisional Patent Application Serial No. 60/308,394 filed Jul. 26, 2001.

### FIELD OF THE INVENTION

This invention relates to tunable resonators, and more particularly, to such devices including components, formed from or with a superconducting material.

### BACKGROUND OF THE INVENTION

Ever since their discovery, high-temperature superconducting materials have been considered for use in such devices as thin-film resonators. Use of superconducting materials in electrical devices promises high-quality values (Q) due to low electrical losses. One difficulty with prior art superconductor resonators including superconductors, however, is that the quality factor Q drops off considerably when the frequency changes slightly from a relatively narrow-frequency operating range.

Tunable high frequency stripline superconductor resonators have been described by D. E. Oates et al. in “Tunable YBCO Resonators on YIG Substrates,” IEEE Transactions on Applied Superconductivity, Vol. 7, Issue 2, at 2338 (June 1997) (incorporated herein by reference). In addition, high frequency RF resonators have been discussed by Q. Y. Ma in “RF Applications of High-Temperature Superconductors in MHz Range,” IEEE Transactions on Applied Superconductivity Vol. 9, Issue 2 (June 1999) (incorporated herein by reference). Superconductor resonators are designed based on their intended operating frequencies. A resonator designed using prior techniques to operate at such high frequencies as radio frequencies (in the MHz range) and above would be prohibitively large and heavy, thereby making such superconductor resonators unsuited for perhaps their most desirable applications, such as aviation, communications, space, etc., where size and weight are at a premium.

It would therefore be desirable to provide a high quality value (Q) for a tunable, high frequency resonator that would operate over a relatively broad frequency bandwidth.

### SUMMARY OF THE INVENTION

It is therefore desired to provide a tunable superconductor resonator comprising a coil, a first superconductor film portion, a second superconductor film portion, and an actuator. The first superconductor film portion is electrically connected to the coil. The second superconductor film portion is electrically coupled to the first superconductor film portion. An actuator is provided that is capable of providing displacement of the first superconductor film portion relative to the second superconductor film portion to change the capacitance between the second superconductor film portion and the first superconductor film portion. In one aspect, the actuator includes a micro-electromechanical (MEM) component or a mini electric motor component that has the capability of relatively displacing the second superconductor film portion and the first superconductor film portion to change a resonant frequency of the tunable superconductor resonator.

### BRIEF DESCRIPTION OF THE DRAWINGS

FIG. 1 shows a top view of one embodiment of a superconductor resonator;

FIG. 2 is a top view of another embodiment of a superconductor resonator;

FIG. 3 is a top view of yet another embodiment of superconductor resonator;

FIG. 4 is a top view of one embodiment of a superconductor filter;

FIG. 5, including FIGS. 5A, 5B, and 5C, shows one embodiment of a superconductor resonator, wherein FIG. 5A shows a perspective view of the superconductor filter; FIG. 5B shows a top view of a portion of the superconductor resonator shown in FIG. 5A; and FIG. 5C shows a top view of another portion of the superconductor resonator shown in FIG. 5A;

FIG. 6 shows another embodiment of a superconductor resonator, including an embodiment of a micro electromechanical (MEM) actuator; and

FIG. 7 shows another embodiment of a superconductor resonator, including an embodiment of a mini electric motor actuator.

Throughout the figures, the same reference numerals and characters are used, unless otherwise stated, to denote like features, elements, components or portions of the illustrated embodiments.

### DETAILED DESCRIPTION OF THE EMBODIMENTS

This disclosure relates to multiple embodiments of a tunable superconductor resonator 100 (such as are typically either stand-alone devices, or integrated in such devices as superconductor filters). In addition, this disclosure relates to the actuators and manufacturing techniques associated with the tunable superconductor resonator 100.

1. Tunable Superconductor Resonators

The tunable superconductor resonator 100 includes a coil that is tuned using piezoelectric actuators, micro electromechanical (MEM) actuators, or mini electric motor actuators. The tunable superconductor resonator 100 may be applied to electronic or optical systems. Many embodiments of superconductor filters include superconductor resonators.

In this disclosure, the term “superconducting” describes a material whose electrical resistance decreases to effectively zero when the temperature of the material is reduced below a critical temperature (Tc) value; the electrical current density of the material is reduced below a critical electrical current density (Jc) value; or the magnetic field applied to the material is below a critical magnetic field (Hc) value. The term “superconductor” describes a device, object, or other apparatus that includes a component that is at least partially formed from a superconducting material. The values of Jc, Tc, and H, of superconducting materials are each dependant on the chemical composition of the material and on the presence or absence of defects in the superconducting material.

The term “superconducting material” includes, but is not limited to, so called high-temperature superconducting materials, metallic superconducting materials, compound superconducting materials, and oxide superconducting materials. It is preferred that so-called high-temperature superconductor materials be used. Metallic superconducting materials include those superconducting materials that are formed from a single metal, such as Nb. Compound superconducting materials include those superconducting materials that are formed from a compound of materials, such as MgB₂, NbSe, and NbTi. Oxide superconducting materials include those superconducting materials that are formed from oxides of compound or metallic superconducting materials. Oxide superconducting materials include superconducting oxides of metallic or compound materials, such as YBaCuO and TlBaCaCuO. Specific examples of superconducting materials are intended to be exemplary in nature (and not limiting in scope), since a wide selection of superconducting materials is presently known and more superconducting materials are often being discovered.

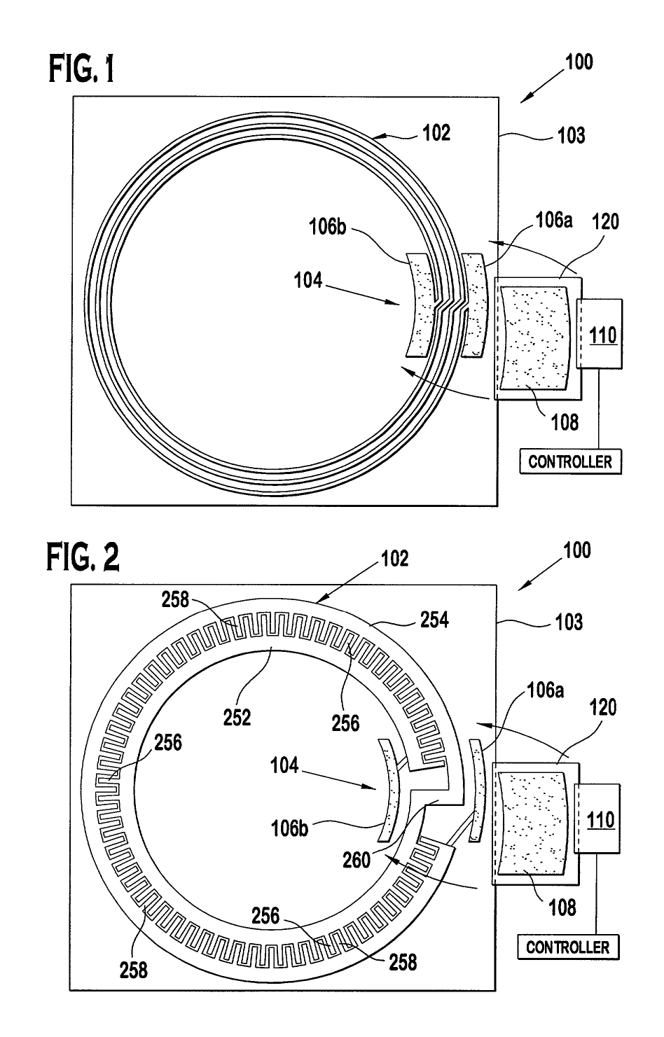

FIG. 1 is a plan view of one embodiment of a tunable superconductor resonator 100 that includes a resonator coil. The embodiment of resonator coil shown in FIG. 1 is a spiral coil. Coils included in the superconducting resonator are formed from superconducting material layered on a substrate. This disclosure describes tuning the superconductor resonator by providing a variable capacitance portion whose capacitance varies as a function of the displacement of the MEM device.

Operationally, any superconductor resonator only resonates at frequencies within a limited frequency range. The embodiment of tunable superconductor resonator 100 shown in FIG. 1 includes a resonator coil 102 that is deposited on a fixed substrate 103 and a variable capacitance portion 104. The tunable superconductor resonator 100 is capable of receiving and transmitting signals in a known manner. The variable capacitance portion 104 includes a plurality of first superconductor film portions 106a, 106b, a second superconductor film portion 108, and an actuator 110. The resonant frequency of the resonator coil 102 can be tuned to have a consistent resonant frequency once it is fabricated.

The first superconductor film portion 106a is electrically connected to an opposed end of the resonator coil 102 from the first superconductor film portion 106b. A variation in the capacitance applied to the first superconductor film portions 106a, 106b of the variable capacitance portion 104 alters the natural or resonant frequency of the resonator coil 102. The first semiconductor film portions 106a, 106b and the resonator coil 102 are both layered on, or deposited on, a face of the fixed substrate 103. The second superconductor film portion 108 is layered on, or deposited on, a face of a movable substrate 120. The fixed substrate 103 and the movable substrate 120 provide structural rigidity to their respective superconductor film portions 106, 108.

The movable substrate 120 and the fixed substrate 103 may be configured to be relatively small (for example, 100 μm×100 μm or 1 mm×1 mm) or larger as desired or required by the application. The relatively small dimension of the movable substrate 120 permits the movable substrate 120 to be mounted to, and displaced by, an actuator such as including, e.g. MEM or piezoelectric device. The actuator 110 displaces the movable substrate 120 to relative to the fixed substrate 103 of the variable capacitance portion 104, and thereby alters the capacitance of the variable capacitance portion 104. The variable capacitance portion 104 is considered an inductive device since each one of the first superconductor film portions 106a, 106b is inductively adjusted relative to the second superconductor film portion 108.

Parallel plate superconductor capacitors can be integrated in the variable capacitance portion 104. The respective superconductor materials layered on each of the fixed substrate 103 and the movable substrate 120 can be modeled using known parallel plate capacitance principles. Alternatively the capacitive values of the variable capacitance portion can be modeled empirically. For parallel plate capacitors, one plate is laid on top of, and is positioned proximate to, another plate. Each plate of the two substantially parallel plates may be configured in a variety of shapes. The shape and size of the variable capacitance portion 104 can be selected (as can the film forming the resonator coil 102) to provide the desired tunable ranges of natural frequencies. Effective coupling providing tunable capacitance can be provided as desired.

The fixed substrate 103 and the movable substrate 120 of the tunable superconductor resonator 100 may each be rigid, flexible, or somewhere between rigid and flexible depending on the intended use of the superconductor resonator 100. The variable capacitance of the capacitance portion 104 can be adjusted by the actuator 110 displacing the movable substrate 120 relative to the fixed substrate 103 (resulting in the second superconductor film portion 108 moving relative to the first superconductor film portions 106a, 106b, or vice versa). During normal operations, the movable substrate 120 may be positioned directly above the first superconductor film portions 106a and 106b, as indicated by arrows shown, e.g., in FIGS. 1 and 2. During operation, the superconductor film portion may be layered on either the top or bottom of the movable substrate 120 relative to the first superconductor film portions 106a and 106b. As a result of such displacement between the first superconductor film portions 106a, 106b and the second superconductor film portion 108, the capacitance of the variable capacitance portion 104 is altered. One embodiment of the actuator 110 includes a MEM device to provide for displacement between the second superconductor film portions 108 and the first superconductor film portions 106a, 106b. In different embodiments, the actuator 110 can be configured to displace the first superconductor film portions 106a, 106b, the second superconductor film portion 108, or both in either an axial or lateral direction. Displacement of one of the superconductor film portions 106 or 108 in a lateral direction would be parallel to the plane of the paper taken as shown in FIG. 1.

In certain embodiments of tunable superconductor resonator 100, the resonator coil 102 is formed, or partially formed, from superconducting material bonded to a semiconductor substrate. Since the value of the critical temperature Tc is very low, the superconducting material forming such components as the coils must be refrigerated to controllably allow the superconducting material to be transitioned into, and out of, its superconducting state. If the superconducting material is maintained above its critical temperature T_{c}, the superconducting material will remain in its normal non-superconducting state. The superconducting material can be refrigerated into its superconducting state by, e.g., placing the superconducting material in a cryostatic chamber filled with liquid nitrogen or liquid helium.

This disclosure describes tuning or changing the resonant frequency of a superconductor resonator, such as one including the resonator coil 102, that is formed from a superconducting material deposited on the substrate. One such tuning technique is a static method. The resonant frequency of the resonator coil is related to the speed of light, c, according to the Equation 1:

c=\sqrt{εμ} [Equation 1]

where δ is the dielectric constant of the material and μ is permeability of the material. The dielectric constant ε can be changed to change the resonant frequency of the superconductor resonator (i.e., to tune the superconductor resonator). A piece of dielectric material, called a ferrite, can be deposited on the resonator coil 102 of the superconductor resonator to change the dielectric constant ε and therefore the resonant frequency of the coil 102. The ferrite material (in one embodiment known as YEG) is deposited on the resonator coil 102, and then a current is passed into this material or voltage is applied across this material to change the dielectric constant of this material. This change in the dielectric constant ε thereby changes the frequency of the superconductor resonator.

The embodiments of tunable superconductor resonator 100 using MEM devices or mini electric motors may be configured to operate in the frequency range typically devoted to telecommunication devices (from 1 MHz to 5 GHz). The superconductor resonators can also be applied to microwave, space, and other applications extending in frequency to 20 GHz and above.

Certain embodiments of the tunable superconductor resonator 100, such as included in tunable filters, generally include a resonator coil that may be connected to, or electrically coupled to, the variable capacitance portion. Certain embodiments of the variable capacitance portion may incorporate a so-called flip circuit that includes a first flip circuit portion and a second flip circuit portion. The first flip circuit portion and the second flip circuit portion are fabricated individually. To provide an operational flip circuit following the fabrication, one of the flip circuit portions is physically flipped over so the faces (tops) of both flip circuit portions face each other. Flip chips are currently commercially available from a variety of vendors in the semiconductor industry. Flip chips can operate within a micron tolerance.

The dielectric constant 6 of the superconducting material of the superconductor resonator can be altered to tune the superconductor resonator. If voltage is applied across dielectric material, the dielectric constant of the material changes. Changing the permeability μ of the superconductor material in a magnetic case is referred to as magnetic coupling. The resonator coil 102 is coated with a ferromagnetic material, after which a magnetic field is applied to the resonator coil 102 to change the permeability μ. An electrical field is then applied to the resonator coil 102 to change the dielectric constant ε. This embodiment of tuning a resonator is therefore static. Once other material is deposited onto the resonator coil 102, the property of the tunable superconductor resonator 100 changes. The superconductor resonator is formed with an inductance portion and a capacitance portion. The resonator coil 102 acts as the inductor portion. When the capacitance of the variable capacitance portion 104 is altered, the resonant frequency of the superconductor resonator is changed.

FIG. 2 shows an embodiment of superconductor resonator 100 from that shown in FIG. 1 including resonator coils 120. The resonator coils in FIG. 2 are in the form of an interdigital coil. The resonator coil 120 includes a plurality of interdigital coil segments 252, 254. The interdigital coil segment, 252, 254 include extending interdigital fingers 256, 258 that extends radially in the space between turns from both the inner interdigital coil segment 252 and the outer interdigital coil segment 254. The interdigital coil segments 252, 254 with their respective interdigital fingers 256, 258 can be relatively displaced to alter the capacitance of the resonator coil 102 to control or tune the resonant frequency of the resonator coil 102, and therefore the tunable superconductor resonator 100. Interdigital fingers 256 are interspaced with, and are capacitively coupled to, adjacent interdigital fingers 258. The interdigital fingers 256 and 258 can extend completely around the circumference of the resonator coil 102, or alternatively certain regions of the interdigital fingers 256, 258 can be removed (or not added) to adjust the inductive capacitance coupling of the resonator coil 102. The resonator coil 102 can be alternatively formed in the spiral embodiment of resonator coil 102 shown in FIG. 1, or the interdigital embodiment of resonator coil 102 shown in FIG. 2.

Other embodiments of the tunable superconductor resonator 100 may be configured in a circular, rectangular or other closed-loop configuration. In one embodiment, each side of the resonator coil or inductor is a square having 25 mm sides and is 2 mm thick. The non-movable portion of the variable capacitor can be formed of two portions each of 5 mm square and separated by 0.5 mm. In one exemplary embodiment, the movable portion of the variable capacitor can be 5 mm in width and 10 mm in length and separated from the non-movable portion of the variable capacitor by spacing ranging from a few microns to a few millimeters.

The actuator 110 of the variable capacitance portion 104 of the in FIGS. 1 and 2 embodiments of tunable superconductor resonator 100 includes a physically small micro electromechanical (MEM) device. The actuator 110 including a MEM provides for adjustment of the resonant frequency of the superconductor resonator by laterally displacing the second superconductor film portion 108 relative to the first superconductor film portions 106a, 106b.

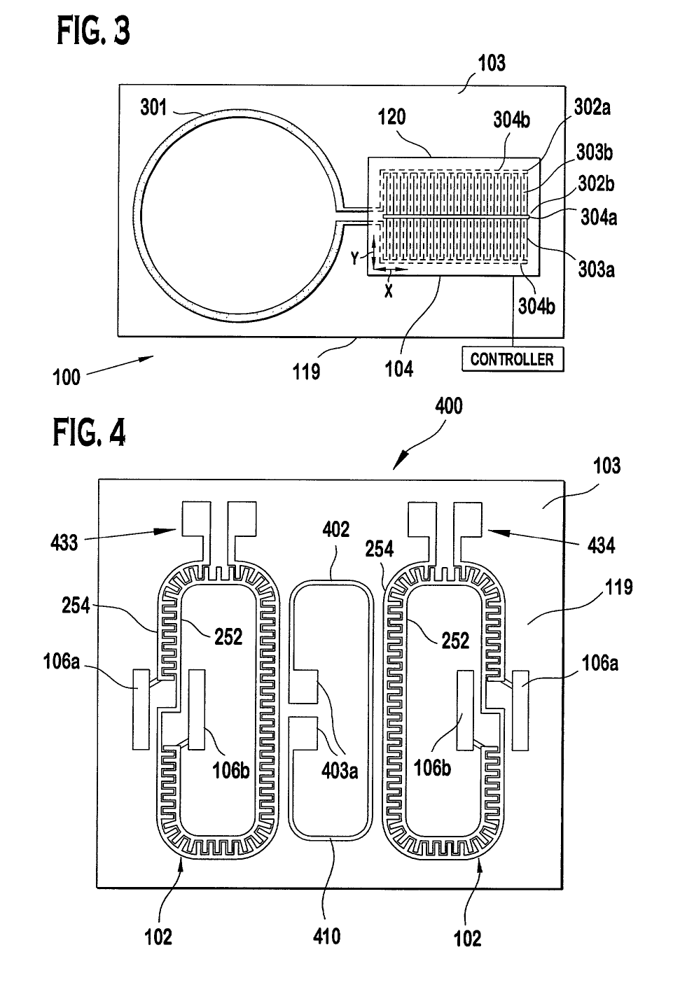

Another embodiment of tunable superconductor resonator 100 is shown in FIG. 3. The tunable superconductor resonator 100 can be provided with a superconductor inductor 301 and a variable capacitance portion 104 that consists of two portions, a non-movable portion 302a and a movable portion 302b. The non-movable portion 302a is formed on a fixed substrate 103 having at least one trunk connector 304b connected to the fixed substrate 103. At least one movable portion 302a is connected to the movable substrate 120. Each trunk conductor 304a has a plurality of interdigital fingers 303a. The trunk connector 304b has a plurality of interdigital fingers 303b. The interdigital fingers 303b of the movable portion 302b are in movable juxtaposition with the interdigital fingers 303a of the non-movable portion 302a. The combined interdigital fingers 303a, 303b thus form an interdigital capacitor structure. This embodiment provides greater capacitance change resulting from relative displacement between the movable and non-movable portions. Therefore, a greater range of tuning of resonant frequency is provided by a similar change of position of the movable portion 302b relative to the non-movable portion 302a.

The dimensions, numbers, and arrangement of the interdigital fingers 303a, 303b can be selected in accordance with the desired range of the natural frequency of the superconductor system. Relative displacement of the plurality of interdigital fingers 303b relative to interdigital fingers 303a results in variation of the capacitance of the variable capacitance portion 104, and a resultant variation in the resonant frequency of the superconductor resonator.

The dimensions of each interdigital finger 303a, 303b are in the range of microns to millimeters. Each adjacent pair of interdigital fingers 303a, 303b acts as a capacitor. In this manner a relatively small interdigital finger structural device can provide considerable capacitance. Additionally, slight movements between the non-movable portion 302b relative to the movable portion 302b can provide considerable changes in capacitance of the variable capacitance portion 104. The more pairs of interdigital fingers provided, the greater the variation in capacitance resulting from a similar motion of the movable portion 302a relative to the non-movable portion 302b, (since a basic electrical capacitor is formed from two electrodes separated by an electrical insulator when the capacitance of the variable capacitance portion 104 can be altered by adjusting the insulation between the contacts). The embodiments of the including variable capacitance portion 104 interdigital fingers provide an air gap between each pair of adjacent interdigital fingers. The sum of capacitance provided by all of the adjacent pairs of interdigital fingers will provide the total capacitance for the variable capacitance portion 104. Therefore, changing the distance between, or number of, pairs of interdigital fingers can be alter the total capacitance of the variable capacitance portion 104.

The embodiment of tunable superconductor filter 400 shown in FIG. 4 include a plurality of superconductor resonator coils 102 (such as those shown relative to FIGS. 1 and 2). Input coupling structures 433 is connected to one superconductor loop resonator coil 102. Output coupling structures 434 is connected to another resonator coil 102. An input electric signal is applied to the input coupling structure 433 while an output electric signal is received at the output coupling structure 434. Either of the input coupling structure 433 or the output coupling structure 434 can be provided on either face of the fixed substrate 103 for respectively transmitting or receiving a signal. The input coupling structure 433 is operatively coupled to at least one of the superconductor resonators, and at least one output coupling structure 434 is also operatively coupled to one of the resonators coils 102.

The input and output coupling structures 433, 434 can be formed as metallic inductor elements or formed from a superconducting material. Forming the input and output coupling structures from a superconducting material, such as the material used to form the tunable superconductor filter 400, offers advantages in maintaining high quality values (Q) and low insertion loss.

While the embodiment of tunable superconductor filter 400 shown in FIG. 4 illustrates a three-pole filter configuration including superconductor resonators coils 102., it will be appreciated that n-pole configurations (where n is the number of coils 102) included in the tunable superconductor filter 400, remain within the scope of the present invention. The resonator coil 410 inductively couples the adjacent resonators coils 102. The dimensions of the coupling structures 433, 434 depend partially on the dimensions of the corresponding resonator coil 102. The tunable superconductor filter 400 shown in FIG. 4 can be fabricated on a single fixed substrate 103. In one embodiment, each resonator coil 110 is about 25 mm in length, 12 mm in width and 2 mm in thickness from an outer edge to an inner edge.

Only the fixed portion of the variable capacitance portion 104 on the fixed substrate 103 (and not the movable substrate 120 or the movable portion 302a) is illustrated in FIG. 4 for ease of display. The non-movable portion 302b of the variable capacitance portion 104 can be rectangular with dimensions of about 5 mm by 10 mm and separated from a corresponding movable portion 302a by 1μ to 3 mm. In turn, each tunable superconductor resonator 100 can be separated from another at their proximate sides by about 2 mm. The input coupling structure 433 and the output coupling structure 434 can be disposed, in one embodiment, from 0.1 mm to 1 mm from the superconductor loop 410 and non-movable portion of the variable capacitance portion 104.

A tunable superconductor filter 400 can be provided wherein each of the resonators coils 102 are resonant at substantially the same frequency or are resonant at a range of tunable frequencies. Thus, according to the three-pole design of tunable superconductor filter 400 shown in FIG. 4, three actuators 110 can be applied to tune the resonator coils 102, and therefore tune the bandwidth of the filter as well as the center frequency of the filter.

If the overlay of the movable portion 302a relative to the capacitor plates 403 in the variable capacitance portion 104 is changed by the same percentage of the change of the length of the capacitor plates 403 (indicating that one of the capacitor plates has shifted by, e.g., half of its length (or width), then the frequency of the filter changes accordingly. The actuators 110 (see FIGS. 1 and 2) laterally displace the movable substrate 120. The resonator in the filter therefore can be tuned to adjust the filtering characteristics of the tunable superconductor filter 400. It is emphasized that any filter configuration that includes a resonator coil 102 is within the intended scope of the present invention.

In this manner, the coupling structure provides a tunable variable capacitor for matching impedance with the equipment using the tunable superconductor resonator. An alternative embodiment is possible wherein the coupling structure is provided as a superconductor resonator for higher Q and lower insertion losses. In operation, the first actuator 110 and first movable portion 302a generally have primary effects on the resonant frequency applied to the tunable superconductor resonator 100. The second actuator 110 adjusts the second movable portion 302a to effect a change in the impedance applied to the tunable superconductor resonator 100. Thus, both the resonant frequency and characteristic impedance of the device can be tuned.

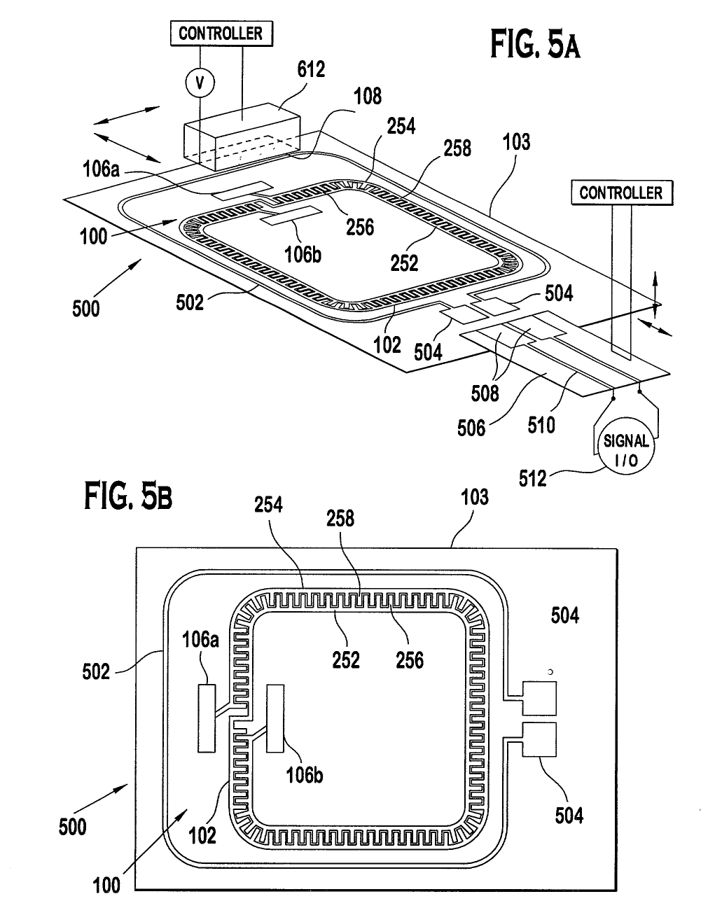

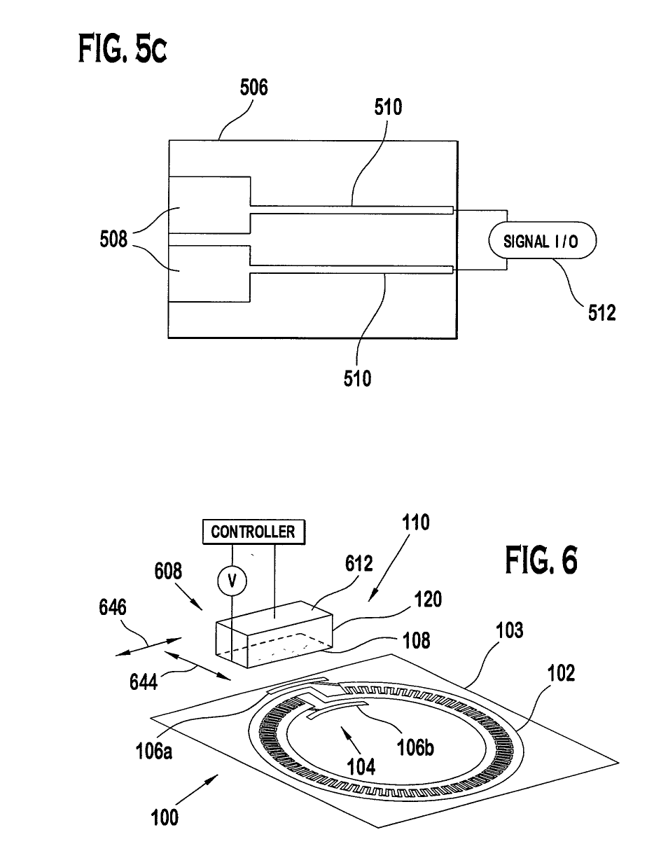

One embodiment of a superconductor resonator coil assembly 500 is shown in FIG. 5 comprising FIGS. 5A, 5B, and 5C. FIG. 5A shows a perspective view of the superconductor resonator coil assembly 500. The superconductor resonator coil assembly 500 includes a tunable superconductor 100, including the resonator coil 102, different embodiments of which are configured as described herein relative to FIGS. 1, 2, 3, 4, 6, and 7. The superconductor resonator coil assembly 500 additionally includes an impedance matching circuit 511 and a pick-up loop 502 formed of a layered superconductor material. The impedance matching circuit 511 includes at least one non-movable I/O pads 504 (two are shown), at least one movable I/O pad 508 (two are shown), and an electrical conductor 510. Each of the pick-up loop 502, the resonator coils 102 of the tunable superconductor resonator 100, and the non-movable PO pads 504 are layered on the fixed substrate 103. The non-movable I/O pads 504 are electrically connected to peripheral ends of the pick-up loop 502. The pick-up loop 502 runs around the periphery of the resonator coil 102. Positioned proximate to the non-movable pads 504 is a movable I/O substrate 506 of the impedance matching circuit 511. The movable I/O substrate 506 includes a plurality of movable I/O pads 508 layered thereupon, one electrical conductor 510 electrically connected to each one of the movable I/O pads 508, and a signal I/O 512 that can provide a signal to and/or receive a signal from at least one of the movable PO pads 508. Due to controllable positioning of the movable I/O pads 508 relative to the non-movable I/O pads 504, a controllable capacitance is provided between the movable I/O pads 508 and the non-movable I/O pads 504. This controllable capacitance can be used to provide an impedance matching between the resonator coil 102 combined with the pick-up loop 502 and whatever circuit is connected to the electrical conductor(s) 510. This displacement between the movable I/O pads 508 and the non-movable PO pads 504 is controlled by the impedance matching controller 580.

One embodiment of a top view of the layering of the pick-up loop portion 502 of the superconductor resonator coil assembly 500 is deposited on the substrate 103 as shown in FIG. 5B. Similarly, one embodiment of the layering of the movable PO substrate 506 of the impedance matching circuit 511 of the superconductor resonator coil assembly 500 shown in FIG. 5C.

Different embodiments of the above-described resonators (and filters) may be configured to provide a variety of resonant frequencies; for example, one embodiment may range from 1 MHz to 10 GHz. Using MEM actuated devices typically provides a resonator ranging in frequency from a few MHz to less than 5 GHz.

2. Tuning of Superconductor Resonators

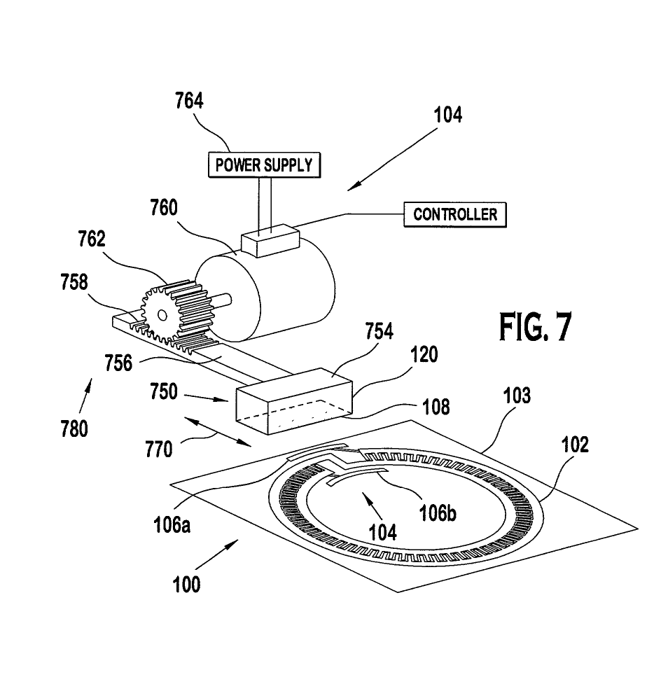

FIG. 6 shows one embodiment of tunable superconductor resonator 100 including an actuator including a MEM. The MEM actuators 612 tune the resonant frequency of the coil resonator 102 included in the tunable superconductor resonator 100. FIG. 7 shows one embodiment of actuator including a mini electric motor that tunes the resonant frequency of the resonator coil 102. In FIGS. 6 and 7, the resonator coil 102 can be configured as a spiral, interdigital, or any other resonator coil generally used in the tunable superconductor resonator 100 above.

FIG. 6 shows another embodiment of tunable superconductor resonator 100 including a resonator coil 102. The resonator coil 102 includes a superconductor resonator coil 102 formed on the substrate 101. The tunable superconductor resonator 100 includes the variable capacitance portion 104. The variable capacitance portion 104 includes a non-movable substrate and a movable substrate. The first superconductor film portions 106a, 106b are generally formed from superconductor material layered on the fixed substrate 103. The superconductor film portions 106a, 106b are generally coplanar with the resonator coil film 102 since both are layered on the fixed substrate 103. The movable substrate portion 108 includes second superconductor film portion 108. The second superconductor film portion 108 is generally arranged parallel to the first superconductor film portions 106a, 106b.

In the embodiment of a tunable superconductor resonator 100 shown in FIG. 6, the MEM actuator 612 can displace the second superconductor film portion 108 relative to the first superconductor film portion 106a, 106b in a generally lateral direction as indicated either by arrow 644 or arrow 646. The MEM actuator 612 is physically connected to the lateral movement of the second superconductor film portion 108 relative to the first superconductor film portions 106a, 106b, which thereby changes the capacitance of the variable capacitance portion 104. Changing the capacitance of the variable capacitance portion 104 changes the resonant frequency of the tunable superconductor resonator 100. In the embodiment of FIG. 6, the coil resonator 102, the first superconductor film portions 106a, 106b, and the second superconductor film portion 108 are formed with superconducting materials.

Actuation of the MEM actuator 612 results in lateral displacement of the second superconductor film portion 108 relative to the first superconductor film portions 106a, 106b in the direction indicated by arrow 644 or 646. Such lateral displacement results in changing the overlap of the second superconductor film portion 108 relative to the first superconductor film portions 106a, 106b. The first superconductor film portions 106a, 106b are each substantially parallel with the second superconductor film portion 108, and the combination of the first superconductor film portion 106a and the second superconductor film portion 108 can be modeled as a parallel plate capacitor, as can the combination of the first superconductor film portion 106b and the second superconductor film portion 108. Therefore, decreasing the physical overlap of the superconductor film portions 106, 108 results in a decrease in the capacitance of the variable capacitance portion 104. Diminishing the capacitance of the variable capacitance portion 104 results in a change within the resonant frequency of the tunable superconductor resonator 100.

FIG. 7 shows an alternate embodiment of a tunable superconductor resonator 100 including a modified embodiment of the variable capacitance portion 104. The variable capacitance portion 104 includes the first superconductor film portions 106a, 106b formed on the fixed substrate 103, the second superconductor film portion 108 formed on the movable substrate 120, an arm 756, gear teeth 758 formed on the arm 756, a gear 762, a driver 760, and a power supply 764 to power the driver 760 that turns the gear 762. The arm 756 is constrained to follow a path parallel to arrow 770 by rollers or other guide devices (not shown). In the embodiment of coil 102 shown in FIG. 7, the variable capacitance portion 104 operates by displacing the second superconductor film portion 108 relative to the first superconductor film portions 106a, 106b in a direction generally indicated by arrow 770.

The elements that interact to displace the movable substrate 120 include the arm 756, the gear teeth 758, the gear 762, the driver 760, and the power supply 764. The combination of the elements 756, 758, 762, 760, and 764 may be characterized as a mini electric motor 780 which is one type of actuator. As such, the mini electric motor 780 in the embodiment in FIG. 7 performs a similar function to the actuator including a MEM 612 shown in FIG. 6; however the allowable displacement may be greater in the embodiment shown in FIG. 7. During operation, the power supply 760 supplies power to rotate the driver 760 and the gear 762 during actuation of the mini electric motor. Rotation of the gear 762 causes engagement with the gear teeth 758 (the gear teeth are arranged along the arm 756) and transversely drives the arm 756 in a direction parallel to arrow 770. The arm 756 is originally fixed to the movable substrate 120, and therefore rotation of the gear 762 results in translation of the movable substrate 120 and the attached superconductor or film portion 108 in a direction indicated generally by arrow 770.

3. Applications and Manufacture of Superconductor Resonators

In many of the embodiments of tunable superconductor resonators and filters, the actuator in the variable capacitance portion includes a MEM or a mini electric motor device. Each MEM or electric motor device or may be configured in a variety of ways, and can be easily constructed using silicon and other superconductor technology. Generally, MEM or mini electric motor devices are designed for their specific applications, frequencies, etc. The above-described embodiments of actuator portions including the MEM or mini electric motor devices may be made on a superconductor resonator. In other embodiments, it may be desirable to construct the MEM or mini electric motor device itself from a superconducting material. Etching a portion of a superconducting film can produce a free standing bridge. These embodiments of tunable superconductor resonators and filters provide for the replacement of bulky actuators by smaller, even miniature, MEM or mini electric motor devices.

The above embodiments of resonators and/or filters using MEM or mini electric motor devices can be applied to communication frequencies (within the 1 MHz to 5 GHz range) including wireless communications and microwave frequencies (that extend to 10 GHz or even higher). These frequencies are often used in space, communication, and military applications. Superconductor resonators tend to be smaller when constructed with MEM or mini electric motor actuators, so resonators can be designed for higher frequencies using MEM or mini electric motor actuators may be applied to the smaller robust resonators and filters used in telecommunication systems. The use of MEM or mini electric motor devices in actuators provides a considerable advantage in any resonator or filter application where miniaturization is desired, such as in digital cameras. Designing the resonator or filter circuit using the MEM or mini electric motor devices requires different activation distances for different resonator or filter layout dimensions depending upon the applicable frequency of the resonator or filter circuit. These operational constraints demand a device such as a MEM or mini electric motor device to tune the resonator filter.

Another application for these devices involves coils that could be applied to frequencies utilized by multi-frequency imaging, such as magnetic resonant imaging, used in MRI systems. The tunable superconductor resonator can be used as an MRI probe, thereby allowing one to switch the resonant frequency of the receiver from the magnetic resonance frequency of one particular nuclear spin (H) to that of another (Na) without changing probes. The variable capacitor in the tunable superconductor resonator can be adapted to match the capacitance of the resonator in the MRI detection circuit to realize electric-controlled matching.

Present resonator and filter systems provide a quality factor Q that has a peak and drops off immediately on either side of that peak. The use of superconducting devices permits that peak to be higher, and extend over a wider band of frequencies. In this embodiment, the peak value of Q is 100 times higher, and extends over a wider band of frequencies, than in other prior devices.

The tunable superconductor filter can be used to filter the signal from a conventional receiver or pre-amplifier to get a higher signal-to-noise ratio and lower insertion loss. The tunable superconductor filter can be used in a base station of a cellular communication network that needs high sensitivity and swift channel switching. It can also be used in a MRI probe, since such systems need high sensitivity and may need swift frequency switching to sense resonance signals of nuclei with different spins (H).

The fabrication of one exemplary embodiment of a tunable superconductor resonator is now described. The substrate may be a two-inch lanthanum aluminate (LAO) wafer substrate having a thickness of about 20 mils. A suitable material for the superconductor is yttrium-barium-copper oxide (YBaCuO) that is deposited as a layer with a thickness of 200 nm on the substrate. The YBaCuO film can be deposited on the substrate at a temperature in the range of 700-800° C. using laser ablation or sputtering deposition technique. The LAO substrate and YBaCuO material are available from several commercial vendors, including the E. I. DuPont de Nemours & Company. The critical temperature for the YBaCuO material is approximately 93 degrees K. LAO or sapphire are preferred substrate materials when YBaCuO is used to form the superconductor layer structure because of the high compatibility in lattice matching between the respective crystalline structures of these materials. Other suitable substrate materials include magnesium oxide (MgO) and strontium titanate (StO).

An exemplary resonator or filter can be formed using a YBaCuO film on a clean LAO substrate, effected by a photo-lithographic patterning process according to the following procedure. First, a suitable photoresist is selectively applied to one side of the substrate. To dry the photoresist, the substrate is then typically heated, depending on the properties of the photoresist, the substrate, and the film. After the substrate is allowed to cool, a positive photo mask of the resonator pattern is used to mask the photoresist coated YBaCuO film. The photoresist-coated YBaCuO film is then subjected to exposure to UV-light through the photo mask. The exposed photoresist on the YBaCuO film is placed in a developer solution. Once developed, the resonator pattern can be realized by selectively etching away the appropriate areas of the YBaCuO film.

The substrate should then be cleaned to remove any remaining photoresist. This can be accomplished by placing the substrate in a solvent. To protect the superconductor structure formed on one side from subsequent etching while forming any input and output structures are on another side, a protective layer of photoresist can be applied, dried, exposed, and developed, as described above.

The following method can be employed for forming contact pads on either side of the substrate. The side of the substrate is cleaned to remove dirt and any photoresist. Next, photoresist is applied, dried, and exposed, in a manner substantially the same as described above, except that a negative mask is used for the contact pads. Alternatively, a contact mask pad can be made of aluminum foil if done carefully. The substrate is then submerged in chlorobenzene for 50 seconds and is then developed, as described above. A metallic coating is formed on the contact areas that were cleared by developing the exposed photoresist by depositing 200 nm of Ag and then 100 nm of Au. A lift-off process can then be employed to remove the unexposed superconductor, such as by using acetone. If annealing is desired, the resulting structure can be annealed in a pure oxygen environment. Gold wires can be bonded to the contact pads using a wire bonder.

Fabrication of the movable portion of the superconductor resonator can be accomplished according to the process described above and connected, or otherwise formed, on the movable end of the actuator according to conventional methods. Tuning a superconductor resonator or filter including a MEM or mini electric motor devices actuator uses a relatively small voltage compared with prior-art piezoelectric actuators.

Although the present invention has been described in connection with specific exemplary embodiments, it should be understood that various changes, substitutions and alterations could be made to the disclosed embodiments without departing from the spirit and scope of the invention as set forth in the appended claims. For example, the variable capacitance portion has been described as being a substantially parallel plate substrate configuration where the parallel substrates are displaced relative to each other to vary the capacitance. It is envisioned that one or more of the substrates in the variable capacitance portion could also be relatively bent, twisted, rotated, or otherwise displaced relative to the other or others to provide such variation in capacitance.

What is claimed is:

1. A tunable superconductor resonator comprising:
a coil;
a first superconductor film portion electrically connected to the coil;
a second superconductor film portion electrically coupled to the first superconductor film portion, displacement of the second superconductor film portion relative to the first superconductor film portion changes the capacitance between the second superconductor film portion and the first superconductor film portion, and
an actuator capable of relatively displacing the second superconductor film portion and the first superconductor film portion, which actuator includes a micro-electromechanical (MEM) component that can relatively displace the second superconductor film portion and the first superconductor film portion to change the resonant frequency of the tunable superconductor resonator.

2. The tunable superconductor resonator of claim 1, wherein the first portion further comprises a first substrate, wherein the film and the first superconductor film portion are both mounted to the first substrate.

3. The tunable superconductor resonator of claim 2, wherein the second portion comprises a second substrate, wherein the second superconductor film portion is mounted to the second substrate.

4. The tunable superconductor resonator of claim 3, wherein the actuator relatively displaces the first substrate and the second substrate to change the capacitance between the second superconductor film portion and the first superconductor film portion.

5. The tunable superconductor resonator of claim 1, wherein the coil includes a superconducting portion.

6. The tunable superconductor resonator of claim 1, wherein the coil is spiral shaped.

7. The tunable superconductor resonator of claim 1, wherein the coil includes an interdigital portion.

8. The tunable superconductor resonator of claim 1, wherein the coil is substantially circular in shape.

9. The tunable superconductor resonator of claim 1, wherein an actuator displaces the second superconductor film portion relative to the first superconductor film portion to change the capacitance between the first superconductor film portion and the second superconductor film portion.

10. The tunable superconductor resonator of claim 1, wherein the first superconductor film portion is substantially arranged in a plane.

11. The tunable superconductor resonator of claim 1, wherein a quality factor of the tunable superconductor resonator maintains substantially constant as the coil changes from the first resonant frequency to the second resonant frequency.

12. The tunable superconductor resonator of claim 1, wherein the MEM component can be laterally displaced.

13. The tunable superconductor resonator of claim 1, wherein the coil is substantially rectangular in configuration.

14. The tunable superconductor resonator of claim 1, further comprising a first substrate, wherein the coil and the first superconductor film portion are deposited on the first substrate.

15. The tunable superconductor resonator of claim 14, further comprising a second substrate, wherein the second superconductor film portion is deposited on the second substrate.

16. The tunable superconductor resonator of claim 15, wherein the displacement of the second superconductor film portion relative to the first superconductor film portion is accomplished by moving the second substrate relative to the first substrate.

17. The tunable superconductor resonator of claim 1, wherein the first superconductor film portion and the second superconductor film portion are both formed from a metallic superconductor.

18. The tunable superconductor resonator of claim 1, wherein the first superconductor film portion and the second superconductor film portion are both formed from a compound superconductor.

19. The tunable superconductor resonator of claim 1, wherein the first superconductor film portion and the second superconductor film portion are both formed from an oxide superconductor.

20. The tunable superconductor resonator of claim 1, wherein the first superconductor film portion and the second superconductor film portion are both formed from a high-temperature superconductor (HTS).

21. The tunable superconductor resonator of claim 1, wherein a quality factor of the tunable superconductor resonator remains substantially constant as the coil changes from the first resonant frequency to the second resonant frequency.

22. The tunable superconductor resonator of claim 1, wherein the MEM results in relative displacement in a direction substantially perpendicular to the plane.

23. An apparatus for tuning a superconductor resonator comprising:
a resonator coil;
means for electrically connecting a first superconductor film portion to the resonator coil;
means for electrically coupling a second superconductor film portion to the first superconductor film portion, wherein displacement of the second superconductor film portion relative to the first superconductor film portion changes the capacitance between the second superconductor film portion and the first superconductor film portion, and
means for relatively displacing the second superconductor film portion and the first superconductor film portion using a Micro-Electromechanical (MEM) actuator that can relatively displace the second superconductor film portion and the first superconductor film portion to change a resonant frequency of the superconductor resonator.

24. A method of tuning a superconductor resonator comprising:
providing a coil;
electrically connecting a first superconductor film portion to the coil;
electrically coupling a second superconductor film portion to the first superconductor film portion, wherein displacement of the second superconductor film portion relative to the first superconductor film portion changes the capacitance between the second superconductor film portion and the first superconductor film portion, and
relatively displacing the second superconductor film portion and the first superconductor film portion using a Micro-Electromechanical (MEM) actuator that can relatively displace the second superconductor film portion and the first superconductor film portion to change a resonant frequency of the superconductor resonator.

25. The method of claim 24, wherein the relatively displacing involves a displacement of the first substrate and the second substrate to change the capacitance between the second superconductor film portion and the first superconductor film portion.

26. The method of claim 24, wherein the relatively displacing involves displacement of the second superconductor film portion relative to the first superconductor film portion changes the capacitance between the first superconductor film portion and the second superconductor film portion.

27. A tunable superconductor resonator comprising:
a coil;
a first superconductor film portion electrically connected to the coil;
a second superconductor film portion electrically coupled to the first superconductor film portion, displacement of the second superconductor film portion relative to the first superconductor film portion changes the capacitance between the second superconductor film portion and the first superconductor film portion,
an actuator capable of relatively displacing the second superconductor film portion and the first superconductor film portion, the actuator includes a Micro-Electromechanical (MEM) component that can relatively displace the second superconductor film portion and the first superconductor film portion to change a resonant frequency of the tunable superconductor resonator; and
an impedance matching circuit coupled to the coil.

28. The tunable superconductor resonator of claim 27, wherein the impedance matching circuit further comprises a pick-up loop.
